(19) United States
(12) Patent Application Publication
(10) Pub. No.: US 2017/0039011 A1
(43) Pub. Date: Feb. 9, 2017

(54) PRINTING SYSTEM, PRINTING APPARATUS AND SERVER USED IN THE SYSTEM, MANAGEMENT METHOD OF PRINT DATA, AND MEDIUM

(71) Applicant: CANON KABUSHIKI KAISHA, Tokyo (JP)

(72) Inventor: Ryousuke Suzuki, Kashiwa-shi (JP)

(21) Appl. No.: 15/223,790

(22) Filed: Jul. 29, 2016

(30) Foreign Application Priority Data
Aug. 6, 2015 (JP) 2015-156071

(51) Int. Cl. G06F 3/12

(52) U.S. Cl. CPC G06F 3/1238; G06F 3/1287; G06F 3/1248; G06F 3/1245

(57) ABSTRACT

An object of the present invention is to make it possible to process print data even in the case where a server does not support the format or the protocol of the print data transmitted to a printing apparatus without being passed through the server. The present invention is a printing system including at least a server that holds and manages received print data, and an information processing apparatus that transmits print data to a printing apparatus without passing the print data through the server, and the printing apparatus includes: a print data saving unit configured to save print data received from the information processing apparatus; and an identifier transmission unit configured to transmit an identifier for identifying the saved print data to the server, and the server includes a management unit configured to manage print data saved in the printing apparatus by using the identifier.

### BACKGROUND OF THE INVENTION

Field of the Invention

The present invention relates to a technique to hold print data in a server or in a printing apparatus.

Description of the Related Art

A printing system in which print data created by a terminal device is held in a server and printing is performed by one of a plurality of printing apparatuses based on the held print data has been disclosed in Japanese Patent Laid-Open No. 2003-099212. Further, a system in which management (user management, charging management) of print data transmitted directly to a printing apparatus without being passed through a server is performed by an external server of the printing apparatus has been disclosed in Japanese Patent Laid-Open No. 2014-013472.

### SUMMARY OF THE INVENTION

According to Japanese Patent Laid-Open No. 2014-013472, the printing apparatus transfers the print data transmitted without being passed through the server to the server and the server receives and holds the transferred print data.

Here, generally there is a case where it is possible for a printing apparatus to process various kinds of print data, but the case does not necessarily mean that it is possible for the server side to process all the kinds of print data. For example, as the format of print data that a printing apparatus can process, mentions is made of LIPS of Canon Inc., PostScript of Adobe Systems Inc., PCL of HP Inc., etc., but in many cases, the format of print data to be held on the server side is limited to one of these formats.

Further, there is a case where print data is transferred to a printing apparatus by a communication protocol for print data. For example, by IPP (Internet Printing Protocol), print data including authentication information and parameters used to print the print data is transferred.

With the above in mind, Japanese Patent Laid-Open No. 2014-013472 has such a problem that the server needs to be compatible with the formats and protocols of all the print data that the printing apparatus can process in order to handle the data transferred from the printing apparatus as print data.

The present invention is a printing system including at least a server that holds and manages received print data, and an information processing apparatus that transmits print data to a printing apparatus without passing the print data through the server, and the printing apparatus includes a print data saving unit configured to save print data received from the information processing apparatus and an identifier transmission unit configured to transmit an identifier for identifying the saved print data to the server, and the server includes a management unit configured to manage print data saved in the printing apparatus by using the identifier, at least one of a condition that the server does not support a format of print data transmitted to the printing apparatus without being passed through the server and a condition that the server does not support a protocol that is used at the time of transmission of print data to the printing apparatus without passing the print data through the server is satisfied.

Further features of the present invention will become apparent from the following description of exemplary embodiments (with reference to the attached drawings).

### BRIEF DESCRIPTION OF THE DRAWINGS

FIG. 1 is a block diagram showing a configuration of an entire system;

FIG. 2 is a block diagram showing a hardware configuration of a printing apparatus;

FIG. 3 is a block diagram showing a hardware configuration of a server;

FIG. 4 is a block diagram showing a software module configuration of each apparatus/device within the system;

FIG. 5 is a flowchart of processing in the printing apparatus at the time of reception of print data according to a first embodiment;

FIG. 6 is a flowchart of processing in the server at the time of reception of an identifier;

FIG. 7A, FIG. 7B, and FIG. 7C are each a flowchart of processing in a system according to the first embodiment;

FIG. 8 is a user interface screen that is displayed in the printing apparatus; and

FIG. 9 is a flowchart of processing in a printing apparatus at the time of reception of print data according to a second embodiment.

### DESCRIPTION OF THE EMBODIMENTS

Hereinafter, embodiments of the present invention are explained by using the drawings. However, the following embodiments do not limit the present invention and all the combinations of the features to be explained below are not necessarily indispensable to solve the problems of the present invention. Explanation is given by attaching the same symbols to the same configurations.

### First Embodiment

### Configuration of Printing System

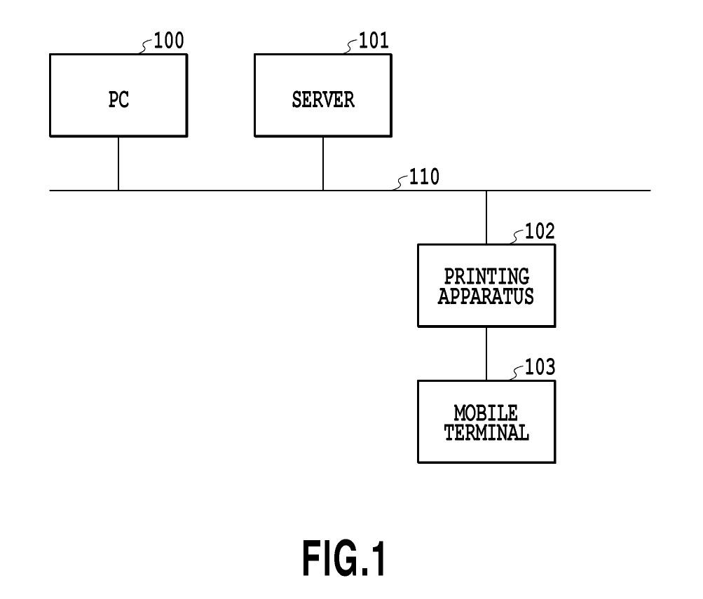

FIG. 1 is a block diagram showing a configuration of an entire printing system in the present embodiment. The printing system includes an information processing apparatus (e.g., personal computer, abbreviated to PC hereinafter) 100, a server 101, a printing apparatus 102, and a mobile terminal 103. The PC 100, the server 101, and the printing apparatus 102 are connected to one another via a network 110 and capable of performing transmission and reception of data with one another.

In the case where a user creates a document by using the PC 100 and prints the created document, the PC 100 receives print parameters (number of copies to be printed or the like) from the user and transmits print data to the server 101.

It is possible for the server 101 to save (hold) a plurality of pieces of print data received via the network 110. Further, the server 101 manages saved print data and transfers the held print data to the printing apparatus 102 in accordance with user instructions that are input to the printing apparatus 102, or deletes the held print data in accordance with user instructions that are input to the PC 100 or the printing apparatus 102. In the present embodiment, transfer, deletion, etc., which are performed for the held print data by the server 101 are called the control of held print data.

The printing apparatus 102 gives the server 101 instructions to perform control to transfer the print data saved in the server 101 to the printing apparatus 102 or to delete the print data. Further, the printing apparatus 102 performs printing processing based on the print data transferred from the server 101 and received via the network 110. In the present embodiment, it is assumed that the format of the print data that is transmitted from the PC 100 to the server 101 is a predetermined format (hereinafter, called a print job data format) in which a print job attribute is given to image data (for example, LIPS format). Further, as the protocol in the case where print data is transmitted from the PC 100 to the server 101, LPR (Line PRinter daemon protocol) is used. Similarly, it is also assumed that the format of print data that is transmitted from the server 101 to the printing apparatus 102 is the print job data format and LPR is used as the protocol.

Further, it is possible for the printing apparatus 102 to perform transmission and reception of data with the mobile terminal 103 by wireless communication. Consequently, it is possible for the mobile terminal 103 to directly transmit print data to the printing apparatus 102 without passing the print data through the server 101. In the present embodiment, it is assumed that the format of the print data that is transmitted from the mobile terminal 103 to the printing apparatus 102 is the PDF format of Adobe Systems Inc. Further, as the protocol in the case where print data is transmitted from the mobile terminal 103 to the printing apparatus 102, IPP (Internet Printing Protocol) is used. IPP is a protocol capable of notifying a printing apparatus of a print job attribute, such as the number of copies to be printed and the print layout, in addition to the print job name and the job owner name.

### <Configuration of Printing Apparatus>

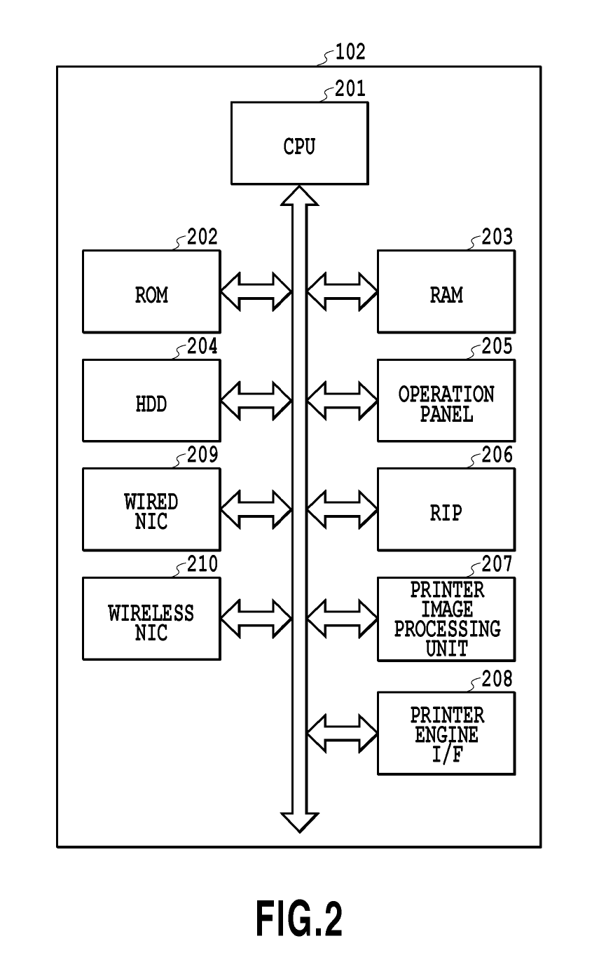

FIG. 2 is a block diagram showing a hardware configuration of the printing apparatus 102 in the present embodiment. The printing apparatus 102 includes a CPU 201, a ROM 202, a RAM 203, an HDD 204, an operation panel 205, an RIP (Raster Image Processor) 206, a printer image processing unit 207, and a printer engine I/F 208. Further, the printing apparatus 102 includes a wired NIC (Network Interface Controller) 209 and a wireless NIC 210. These components are connected to one another via a bus and capable of performing transmission and reception of data with one another.

The CPU 201 develops various programs stored in the ROM 202 or the HDD 204 onto the RAM 203 and executes the developed programs. Due to this, the CPU 201 centralizedly controls each component and causes the printing apparatus 102 to operate.

In the ROM 202, programs for controlling the operation of the printing apparatus 102 are stored. These programs also include programs for performing processing, to be described later, according to the present embodiment. Further, in the ROM 202, data for management unique to the printing apparatus 102 is also stored. The RAM 203 functions as a work memory and programs stored in the ROM 202 or the HDD 204 are developed onto the RAM 203, or temporary data is stored in the RAM 203. In the HDD 204, print data received from the mobile terminal 103 is stored (held).

The operation panel 205 includes a display panel having a touch panel function and a hardware key. On this display panel, a UI (User Interface) screen that is created in the RAM 203 by the CPU 201 is displayed. A user operates the printing apparatus 102 by using the touch panel, the hardware key, etc. Then, the CPU 201 receives an input of a user via the operation panel 205.

The RIP 206 creates a raster image (bitmap image) from a page description language (PDL) code. The printer image processing unit 207 performs resolution conversion processing and correction processing, which are suitable to a printer engine, for the image file created by the RIP 206. Between the printer engine I/F 208 and the printer engine (not shown), data (bit map images, printing processing commands, etc.) is transmitted and received and the printer engine performs processing to perform printing on a printing medium based on the sent data.

The CPU 201 performs data communication with the server 101 via the wired NIC 209. The CPU 201 performs data communication with the mobile terminal 103 via the wireless NIC 210.

### <Configuration of Server>

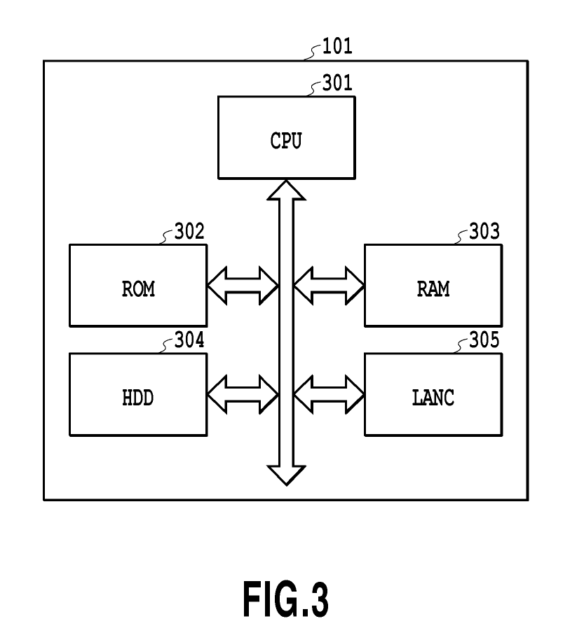

FIG. 3 is a block diagram showing a hardware configuration of the server 101 in the present embodiment. The server 101 includes a CPU 301, a ROM 302, a RAM 303, an HDD 304, and a LANC (LAN Controller) 305. These components are connected to one another via a bus and capable of performing transmission and reception of data with one another.

The CPU 301 develops various programs stored in the ROM 302 or the HDD 304 onto the RAM 303 and executes the developed programs. Due to this, the CPU 301 centralizedly controls each component and causes the server 101 to operate.

In the ROM 302, programs for controlling the operation of the server 101 are stored. These programs also include programs for performing processing, to be described later, according to the present embodiment. Further, in the ROM 302, data for management unique to the server 101 is also stored. The RAM 303 functions as a work memory and programs stored in the ROM 302 or the HDD 304 are developed onto the RAM 303, or temporary data is stored in the RAM 303. In the HDD 304, print data received from the PC 100 is stored (held).

The LANC 305 is one kind of wired network interface controller and the CPU 301 performs data communication with the PC 100 and the printing apparatus 102 via the LANC 305.

### <Module Configuration of Software>

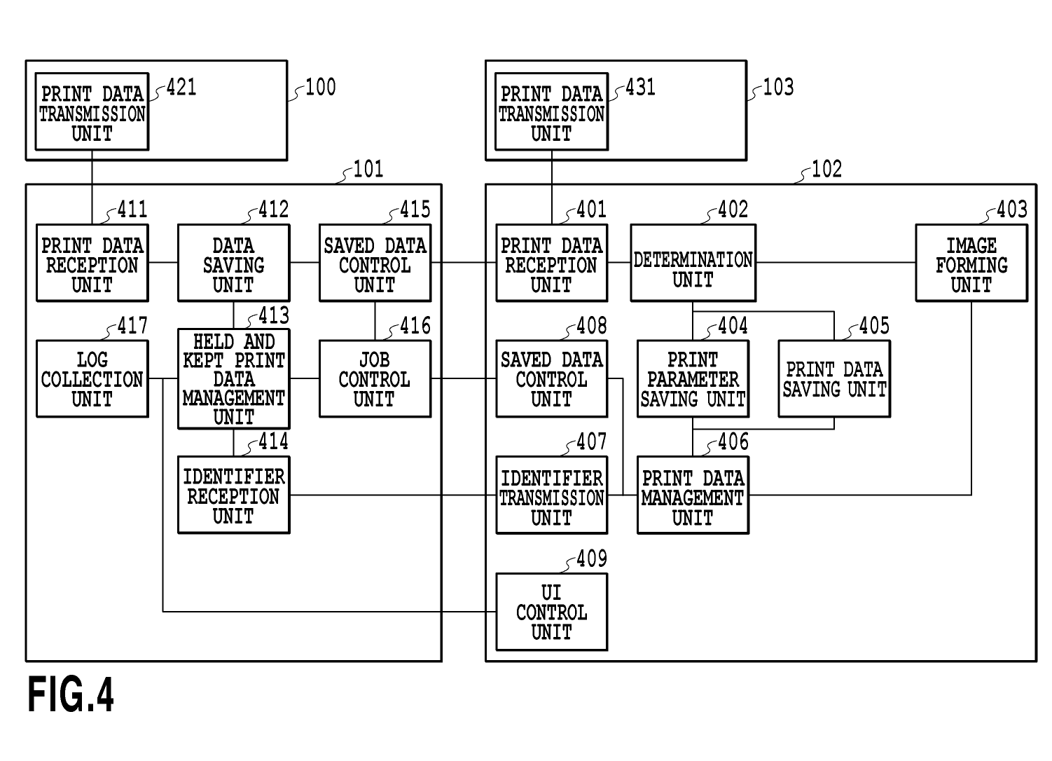

FIG. 4 is a block diagram showing a software module configuration of each apparatus/device within the system in the present embodiment.

A print data transmission unit 421 of the PC 100 transmits print data to the server 101 via a wired LAN by using LPR. A print data transmission unit 431 of the mobile terminal 103 transmits print data to the printing apparatus 102 via a wireless network by using IPP.

The software modules of the server 101 are explained. A print data reception unit 411 receives print data transmitted from the PC 100 by controlling the LANC 305. Then, a data saving unit 412 stores the received print data in the HDD 304. At this time, it may also be possible for the print data reception unit 411 to interpret the print job name, the job owner name, the address information on the source of transmission in the LPR communication, etc., included as a print job attribute, and for the data saving unit 412 to store information on the interpretation results in the HDD 304 in association with the print data.

The print data stored by the data saving unit 412 is managed by a held print data management unit 413 by using a list. Further, the held print data management unit 413 also manages the print data stored in the printing apparatus 102 that can be specified by an identifier transferred from an identifier reception unit 414 by using a list.

The held print data management unit 413 receives a request for the processing, such as execution of printing based on the managed print data and deletion of the print data, by communicating with the printing apparatus 102. Upon receipt of the request to process the print data managed by the held print data management unit 413, the held print data management unit 413 notifies a job control unit 416 of the contents of the request. The job control unit 416 notified of the contents of the request determines whether the print data to be processed is the print data stored in the HDD 304 by the data saving unit 412 or the print data stored in the HDD 204 of the printing apparatus 102. In the case where the results of the determination indicate that the print data to be processed is the print data stored in the HDD 304 by the data saving unit 412, the job control unit 416 sends a command to process the print data to a saved data control unit 415. On the other hand, in the case where the results of the determination indicate that the print data to be processed is the print data stored in the HDD 204 of the printing apparatus 102, the job control unit 416 sends a command to process the print data to the saved data control unit 408 of the printing apparatus 102.

In the case where the control (addition or deletion of the print data, execution of printing based on the print data, etc.) for the print data is performed, a log collection unit 417 collects the contents of the processing for the print data stored in the HDD 204 or the HDD 304 as a log. The list is updated based on the collected log and the held print data management unit 413 continues to manage the print data by using the list after the updating.

Subsequently, the software modules of the printing apparatus 102 are explained. A print data reception unit 401 receives print data transmitted from the server 101 or the mobile terminal 103 by controlling the wired NIC 209 or the wireless NIC 210.

The print data reception unit 401 determines the protocol by the physical port, the port number of the network, etc., used at the time of transmission of the print data and performs processing in accordance with the results of the determination for the received print data. In other words, the print data reception unit 401 performs processing to separate the print data into image data and a print job attribute for the print data (print job data format) received from the server 101. On the other hand, the print data reception unit 401 performs processing to specify a print job attribute according to IPP for the print data (PDF format) received from the mobile terminal 103. The print job attribute may include the print job name, the job owner name, etc.

In the case where the print data reception unit 401 receives the print data, a determination unit 402 determines whether or not the source of transmission of the received print data is the server 101. Here, it may also be possible for the determination unit 402 to perform the determination based on, for example, the IP address of the source of transmission of the received print data.

In the case where the results of the determination by the determination unit 402 indicate that the source of transmission of the received print data is the server 101, an image forming unit 403 forms an image on a printing medium based on the image data and the print job attribute separated in the print data reception unit 401.

On the other hand, in the case where the results of the determination by the determination unit 402 indicate that the source of transmission of the received print data is a device other than the server 101, a print parameter saving unit 404 stores the print job attribute specified in the print data reception unit 401 in the HDD 204. Further, a print data saving unit 405 stores the print data in the HDD 204 and holds the print data in the printing apparatus 102. At this time, it may also be possible for the print parameter saving unit 404 to store the address information or the like on the source of transmission in the network communication in the print data reception unit 401 in the HDD 204 in association with the print job attribute.

A print data management unit 406 manages the data stored in the HDD 204 by the print parameter saving unit 404 and the print data saving unit 405. Specifically, in the case where data to be managed is stored in the HDD 204, the print data management unit 406 allocates an identifier for uniquely identifying the data within the printing apparatus. Then, the print data management unit 406 delivers the identifier to an identifier transmission unit 407.

The identifier transmission unit 407 transmits the identifier delivered from the print data management unit 406 to the identifier reception unit 414 by controlling the wired NIC 209. At this time, it may also be possible for the identifier transmission unit 407 to transmit information on part or all of the print job attribute stored in the HDD 204 by the print parameter saving unit 404, the IP address of the source of transmission of the print data, network information (for example, IP address) on the printing apparatus 102 itself, etc.

A saved data control unit 408 receives a command transmitted from the job control unit 416 of the server 101. Due to this, the saved data control unit 408 receives printing processing based on the print data and deletion processing, which are specified by the received command. Upon receipt of the printing processing of the print data, the saved data control unit 408 reads the print job attribute of the specified print data and the print data from the HDD 204 and sends a command to perform printing processing based on the read data to the image forming unit 403. Upon receipt of the deletion processing of the print data, the saved data control unit 408 sends a command to delete the specified print data to the print data management unit 406. The print data management unit 406 having received the command deletes the specified print data and the print job attribute corresponding to the print data from the HDD 204.

A UI control unit 409 receives list information on the held print data from the held print data management unit 413 of the server 101, creates a UI screen based on the list information, and displays the created UI screen on the display panel of the operation panel 205. Further, the UI control unit 409 transmits a request to perform control based on an input by a user via the UI screen displayed on the display panel of the operation panel 205 to the held print data management unit 413 of the server 101.

### <Processing at the Time of Reception of Print Data in the Printing Apparatus 102>

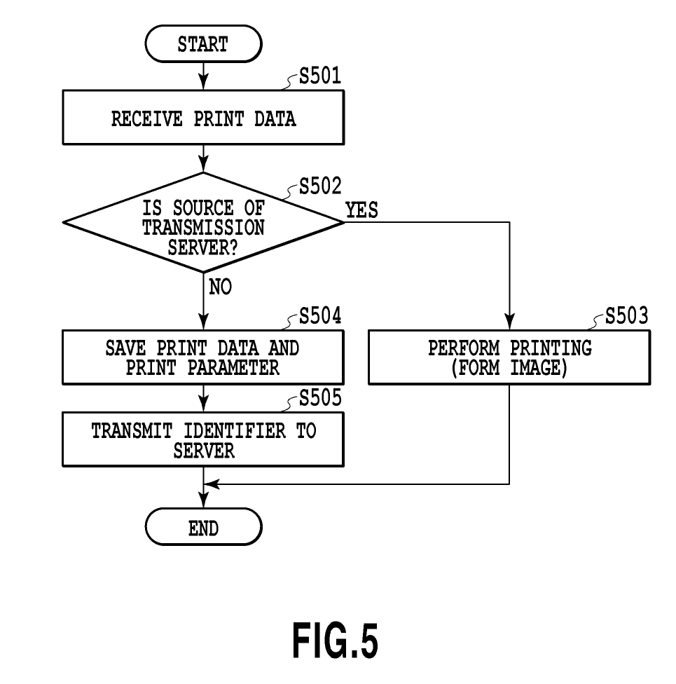

The processing at the time of reception of print data in the printing apparatus 102 is explained by using the flowchart in FIG. 5.

At step S501, the print data reception unit 401 receives print data by controlling the wired NIC 209 or the wireless NIC 210.

At step S502, the determination unit 402 determines whether or not the source of transmission of the print data is the server 101 by using the network information used at the time of reception of the print data. In the present embodiment, the IP address of the server 101 is registered in advance in the RAM 203 and the determination unit 402 performs determination by comparing the IP address of the source of transmission of the print data with the registered IP address. In the case where the results of the determination by the determination unit 402 indicate that the source of transmission of the print data is the server 101, the processing proceeds to step S503. On the other hand, in the case where the results of the determination indicate that the source of transmission of the print data is not the server 101, the processing proceeds to step S504.

At step S503, the print data reception unit 401 separates the print data into image data and a print job attribute and stores these pieces of information in the RAM 203. Next, the image forming unit 403 performs printing processing to print an image on a printing medium based on the image data and the print job attribute stored in the RAM 203.

At step S504, the print data reception unit 401 specifies the print job attribute of the print data based on the protocol used at the time of reception of the print data and stores the print job attribute in the RAM 203. Next, the print parameter saving unit 404 stores the print job attribute stored in the RAM 203 in the HDD 204 and the print data saving unit 405 stores the print data in the HDD 204. In the case where the print job attribute and the print data are stored in the HDD 204, the print data management unit 406 issues a new identifier and associates the issued identifier with the print job attribute and the print data. Further, the print data management unit 406 delivers the newly issued identifier to the identifier transmission unit 407.

At step S505, the identifier transmission unit 407 transmits the identifier delivered from the print data management unit 406 at step S504 to the identifier reception unit 414 of the server 101 via the network.

### <Processing at the Time of Reception of Identifier in the Server 101>

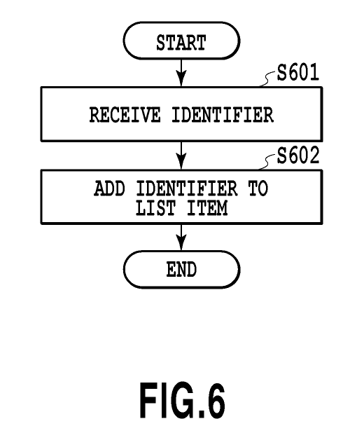

FIG. 6 is a flowchart explaining the processing in the server 101 in the case where the server 101 receives the identifier transmitted from the identifier transmission unit 407 of the printing apparatus 102.

At step S601, the identifier reception unit 414 receives an identifier for uniquely identifying the held print data that has newly become a management target by controlling the LANC 305.

At step S602, the held print data management unit 413 adds the identifier received at step S601 to the list item. At this time, it may also be possible for the held print data management unit 413 to associate the IP address information or the like on the printing apparatus having transmitted the identifier with the added identifier. Due to this, it is made possible for the held print data management unit 413 to uniquely identify the print data even in the case where the printing system in the present embodiment has a plurality of printing apparatuses.

### <Execution of Processing for Held Print Data>

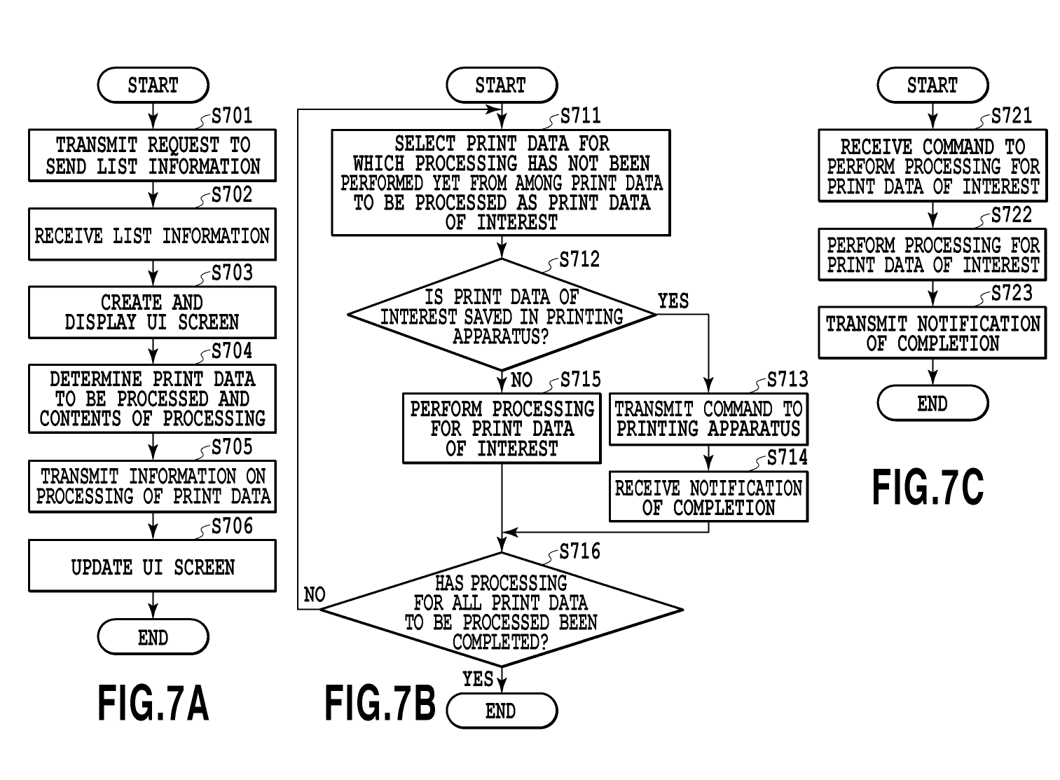

The case where processing for the print data managed by the held print data management unit 413 is performed is explained by using FIG. 7A, FIG. 7B, and FIG. 7C.

FIG. 7A is a flowchart explaining the processing in the printing apparatus 102.

At step S701, the UI control unit 409 transmits a request to send the list information on the print data to the server 101 by controlling the wired NIC 209.

At step S702, the UI control unit 409 receives the list information on the print data transmitted from the server 101 by controlling the wired NIC 209. The list information to be received here may include data of the name of the job of the print data, the job owner name, etc.

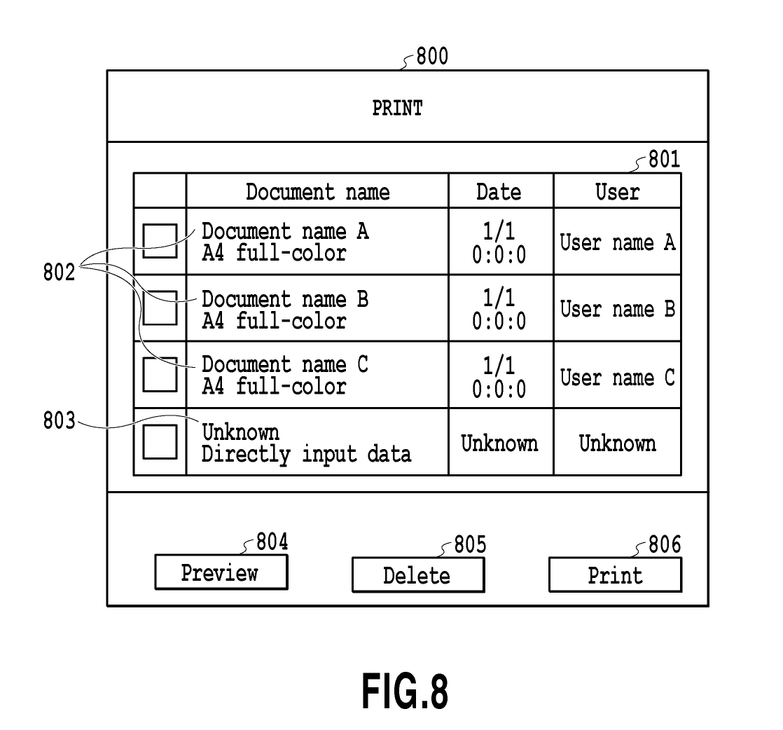

At step S703, the UI control unit 409 creates a UI screen for presenting information to a user and for allowing the user to input based on the list information received at step S702 and displays the UI screen on the display panel of the operation panel 205. Details of the UI screen created at step S703 will be described later (see FIG. 8).

At step S704, the UI control unit 409 determines the print data to be processed and the contents of the processing for the print data based on the user input. At this time, the number of pieces of print data to be processed may be two or more.

At step S705, the UI control unit 409 transmits information indicating the print data and the contents of the processing for the print data determined at S704 to the server 101 by controlling the wired NIC 209.

At step S706, the UI control unit 409 updates the UI screen.

FIG. 7B is a flowchart explaining the processing in the server 101 after the UI control unit 409 transmits the information to the server 101 at step S705 in FIG. 7A.

At step S711, the held print data management unit 413 receives the information indicating the print data and the contents of the processing for the print data transmitted at step S705 by controlling the LANC 305. Then, the held print data management unit 413 selects one piece of the print data for which the processing has not been performed yet from among the print data to be processed as print data of interest. Then, the held print data management unit 413 sends a command to process the print data of interest to the job control unit 416.

At step S712, the job control unit 416 determines whether or not the print data of interest is the print data saved in the printing apparatus 102. In the case where the results of the determination indicate that the print data of interest is the print data saved in the printing apparatus 102, the processing proceeds to step S713. On the other hand, in the case where the results of the determination indicate that the print data of interest is not the print data saved in the printing apparatus 102 (i.e., the print data of interest is the print data saved in the server 101), the processing proceeds to step S715.

At step 713, the job control unit 416 sends a command to process the print data of interest to the saved data control unit 408 of the printing apparatus 102 by controlling the LANC 305.

At step S714, the job control unit 416 receives notification indicating that the processing for the print data of interest has been completed by controlling the LANC 305.

In the case where the results at step S712 are NO, at step S715, the job control unit 416 sends a command to process the print data of interest to the saved data control unit 415. Next, the saved data control unit 415 performs processing for the print data of interest. For example, in the case where the processing to be performed for the print data of interest is printing, the saved data control unit 415 transmits the print data stored in the HDD 304 to the print data reception unit 401 of the printing apparatus 102 by controlling the LANC 305. Alternatively, in the case where the processing to be performed for the print data of interest is deletion, the saved data control unit 415 deletes the print data stored in the HDD 304.

At step S716, the held print data management unit 413 determines whether or not the processing for all the print data to be processed has been completed. In the case where the results of the determination indicate that the processing for all the print data to be processed has been completed, the series of processing is terminated. On the other hand, in the case where the results of the determination indicate that the processing for all the print data to be processed has not been completed yet, the processing returns to step S711.

FIG. 7C is a flowchart explaining the processing in the printing apparatus 102 after the job control unit 416 transmits the command at step S713 in FIG. 7B.

At step S721, the saved data control unit 408 receives the command transmitted at step S713 by controlling the wired NIC 209. The command to be received here includes the identifier issued by the print data management unit 406, and therefore, it is possible for the printing apparatus 102 to uniquely identify the print data of interest. The saved data control unit 408 notifies the print data management unit 406 of the identifier and the contents of the processing for the print data of interest.

At step S722, the print data management unit 406 performs specification processing for the print data of interest.

In the case where the specification processing for the print data of interest has been completed, at step S723, the saved data control unit 408 transmits notification indicating that the specification processing for the print data of interest has been completed by controlling the wired NIC 209, and the series of processing is terminated.

### <User Interface Screen>

FIG. 8 is a diagram showing an example of a UI screen for controlling held print data, which is created by the UI control unit 409 and displayed on the display panel of the operation panel 205. A UI screen 800 has a held print data list 801 and it is made possible for a user to select held print data. In FIG. 8, symbol 802 indicates held print data saved in the server 101 and symbol 803 indicates held print data saved in the printing apparatus 102. Symbols 804 to 806 indicate buttons that are pressed down in the case where processing is performed for the print data selected in the list 801. For example, in the case where the Preview button 804 is pressed down, a preview image in the case where printing processing for the selected held print data is performed is created by the server 101 or the printing apparatus 102 and the preview image is displayed on the display panel of the operation panel 205. In the case where the Delete button 805 is pressed down, the selected held print data, the print job attribute data corresponding thereto, etc., are deleted from the server 101 or the printing apparatus 102. In the case where the Print button 806 is pressed down, printing processing of the selected print data is started.

The information received at step S601 may include the print job name and the job owner name included as the print job attribute, the address information on the source of transmission of the LPR communication, the name of the printing apparatus itself, etc., in addition to the identifier issued by the print data management unit 406. After the UI control unit 409 creates the UI screen based on the information, it is made possible to display the job name and the job owner name also in the held print data list that is displayed on the UI screen. At this time, it may also be possible to display the print data held in the printing apparatus in a color different from the color of the print data held in the server, or to display the print data held in the printing apparatus with the name of the printing apparatus attached to the top of the job name. Due to this, the effect that it is made easy to distinguish the print data held in the printing apparatus from the print data held in the server is obtained.

As explained above, the printing apparatus 102 in the present embodiment interprets print data in the print data reception unit 401 in accordance with the protocol at the time of transmission of the print data. Then, the results of the interpretation are saved by the print parameter saving unit 404 as a print job attribute. Consequently, it is no longer necessary for the server 101 side to interpret the print data received by the printing apparatus 102 without being passed through the server 101 in accordance with the protocol. Because of this, even in the case where the server 101 is incompatible with the protocol of the print data received directly by the printing apparatus 102, it is possible for the server 101 to manage the print data.

In the above-described explanation, the case where the printing apparatus 102 receives print data from the server 101 or the mobile terminal 103 is explained, but it is also possible to apply the present embodiment to, for example, a system in which the PC 100 directly transmits print data to the printing apparatus 102 (without passing the print data through the server 101). In this case, the printing apparatus 102 saves the print data received from the PC 100 in the HDD 204 after separating the print data into print data and a print job attribute. At this time, the print data management unit 406 allocates an identifier to the print data, and therefore, it is also possible for the server 101 to control the print data transmitted directly to the printing apparatus 102 without being passed through the server 101 as well as the print data transmitted to the printing apparatus 102 via the server 101.

In the above-described explanation, the case is explained where the server 101 supports neither format nor protocol for the print data that the printing apparatus 102 receives from the mobile terminal 103. However, it is also possible to apply the present embodiment to a system in which a server that does not support the format of print data transmitted to the printing apparatus without being passed through the server or to a system in which a server does not support the protocol that is used at the time of transmission of print data to the printing apparatus without passing the print data through the server. In other words, it may be possible to apply the present embodiment to a system that satisfies at least one of these conditions.

### Second Embodiment

In the first embodiment, the determination unit 402 of the printing apparatus 102 determines whether or not the source of transmission of the received print data is the server 101. In the present embodiment, in addition to the determination of the first embodiment, the determination unit 402 determines whether or not to save the received print data (whether to save the received print data or to ignore the received print data without saving it) based on a condition set in accordance with a specific IP address and the kind of protocol that is used for transmission of print data. In the following explanation, explanation of the contents in common to those of the first embodiment is simplified or omitted.

The system configuration, the hardware configuration, and the software configuration of the present embodiment are the same as those of the first embodiment (see FIG. 1 to FIG. 4).

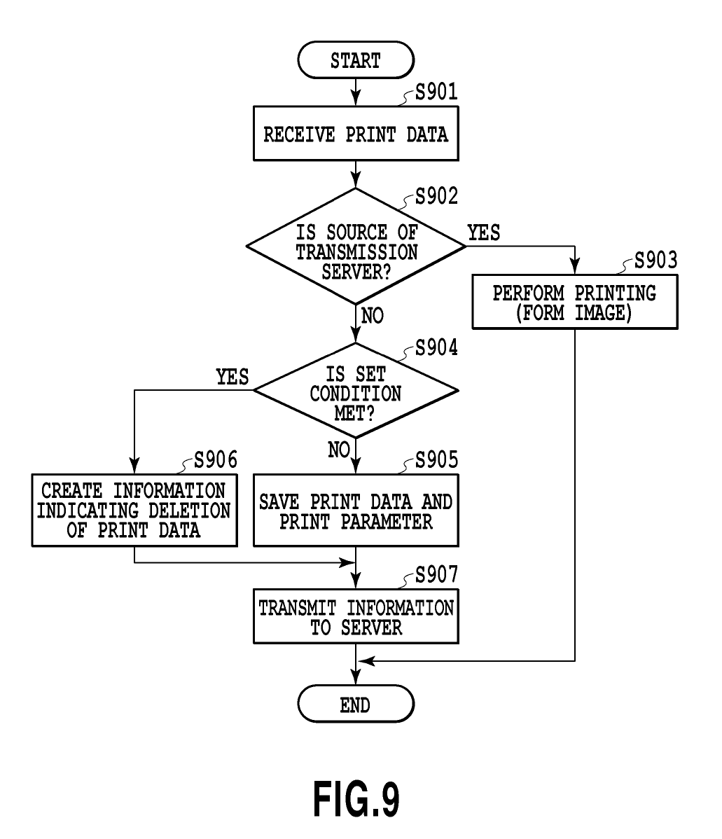

FIG. 9 is a flowchart for explaining processing at the time of reception of print data in the printing apparatus 102 according to the present embodiment.

At step S901, the print data reception unit 401 receives print data by controlling the wired NIC 209 or the wireless NIC 210.

At step S902, the determination unit 402 determines whether or not the source of transmission of the print data is the server 101 by using the network information used at the time of reception of the print data as in the first embodiment. In the case where the results of the determination by the determination unit 402 indicate that the source of transmission of the print data is the server 101, the processing proceeds to step S903. On the other hand, in the case where the results of the determination indicate that the source of transmission of the print data is not the server 101, the processing proceeds to step S904.

At step S903, as in the first embodiment (step S503 in FIG. 5), printing processing to print an image on a printing medium based on the received print data is performed.

At step S904, the determination unit 402 determines whether or not the received print data is data that satisfies the condition set in advance by the printing apparatus 102. This condition set in advance is, for example, a condition for specifying the print data transmitted by wireless communication and the print data transmitted from a specific IP address. In the case where the results of the determination by the determination unit 402 indicate that the received print data satisfies the set condition, the processing proceeds to step S906. On the other hand, in the case where the received print data does not satisfy the set condition, the processing proceeds to step S905.

At step S905, as in the first embodiment (step S504 in FIG. 5), the processing to save the print data and print parameters (specifically, print job attribute) is performed. At this time, the print data management unit 406 issues an identifier with which it is possible to uniquely identify the print data.

At step S906, the determination unit 402 creates information indicating that the received print data is deleted without holding it. At this time the print data management unit 406 issues an identifier with which it is possible to uniquely identify the print data.

At step S907, the identifier transmission unit 407 transmits the information (including the identifier) created at step S905 or step S906 to the identifier reception unit 414 of the server 101 by controlling the wired NIC 209.

The above is the processing at the time of reception of print data in the printing apparatus 102 of the present embodiment.

The identifier reception unit 414 of the server 101 receives information transmitted by the identifier transmission unit 407 of the printing apparatus 102 by controlling the LANC 305. Following this, the held print data management unit 413 adds the identifier included in the information to the list item and immediately after this, deletes the added identifier from the list item.

As explained above, in the present embodiment, the identifier transmission unit 407 transmits the information on the print data that is determined to be ignored without being held by the determination unit 402 of the printing apparatus 102 to the server 101. Due to this, it is made possible for the log collection unit 417 to collect the log for the print data for which the processing, such as holding and printing, is not performed due to the setting on the printing apparatus 102 side, and therefore, it is made possible for the server 101 to mange the print data.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment (s) and/or that includes one or more circuits (e.g., application specific integrated circuit (ASIC)) for performing the functions of one or more of the above-described embodiment (s), and by a method performed by the computer of the system or apparatus by, for example, reading out and executing the computer executable instructions from the storage medium to perform the functions of one or more of the above-described embodiment (s) and/or controlling the one or more circuits to perform the functions of one or more of the above-described embodiment (s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

Due to the present invention, in a printing system in which print data is held in a server and thus the print data is managed, it is possible to process the print data even in the case where a serve does not support the format of the print data transmitted to a printing apparatus without being passed through of the server or the protocol.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-156071, filed Aug. 6, 2015, which is hereby incorporated by reference wherein in its entirety.

What is claimed is:

1. A printing system comprising at least a server that holds and manages received print data, and an information processing apparatus that transmits print data to a printing apparatus without passing the print data through the server, wherein
the printing apparatus includes:
a print data saving unit configured to save print data received from the information processing apparatus; and
an identifier transmission unit configured to transmit an identifier for identifying the saved print data to the server,
the server includes a management unit configured to manage print data saved in the printing apparatus by using the identifier, and
at least one of a condition that the server does not support a format of print data transmitted to the printing apparatus without being passed through the server and a condition that the server does not support a protocol that is used at the time of transmission of print data to the printing apparatus without passing the print data through the server is satisfied.

2. The printing system according to claim 1 wherein
the printing apparatus further includes a determination unit configured to determine whether or not the source of transmission of received print data is the server, and
the printing apparatus performs printing based on the received print data in a case where the determination unit determines that the source of transmission of the received data is the server.

3. The printing system according to claim 1, wherein
the printing apparatus saves a print job attribute, which is obtained by interpreting print data received from the information processing apparatus, in association with the print data.

4. The printing system according to claim 1, wherein
the identifier transmission unit further transmits information on part or all of the print job attribute corresponding to the identifier to the server, and
the management unit manages the print data saved in the printing apparatus by using the information.

5. The printing system according to claim 1, wherein
the management unit manages the print data held in the server and the print data saved in the printing apparatus by using a list and adds the received identifier to the list item in a case where the server receives the identifier.

6. The printing system according to claim 1, wherein
the printing apparatus creates and displays a user interface screen for presenting information on the print data held in the server and information on the print data saved in the printing apparatus to a user.

7. The printing system according to claim 6, wherein
inputting by a user to specify print data and processing for the print data is performed via the user interface screen, and
the printing apparatus transmits a request relating to the print data and the processing for the print data to the server upon receipt of the inputting by the user.

8. The printing system according to claim 1, wherein
the printing apparatus determines whether or not print data received from the information processing apparatus satisfies a predetermined condition, and
in a case where it is determined that the print data received from the information processing apparatus satisfies the predetermined condition, the print data is deleted without being saved and information indicating the deletion is transmitted to the server.

9. A printing apparatus that is used in a printing system including at least a server that holds and manages received print data, and an information processing apparatus that transmits print data to the printing apparatus without passing the print data through the server, the printing apparatus comprising:
a print data saving unit configured to save print data received from the information processing apparatus; and
an identifier transmission unit configured to transmit an identifier for identifying the saved print data to the server, wherein
at least one of a condition that the server does not support a format of print data transmitted to the printing apparatus without being passed through the server and a condition that the server does not support a protocol that is used at the time of transmission of print data to the printing apparatus without passing the print data through the server is satisfied.

10. A server that is used in a printing system including at least a server that holds and manages received print data, and an information processing apparatus that transmits print data to a printing apparatus without passing the print data through the server, the server comprising:
a management unit configured to manage print data saved in the printing apparatus by using an identifier, wherein
at least one of a condition that the server does not support a format of print data transmitted to the printing apparatus without being passed through the server and a condition that the server does not support a protocol that is used at the time of transmission of print data to the printing apparatus without passing the print data through the server is satisfied.

11. A management method of print data that is performed in a printing system including at least a server that holds and manages received print data, and an information processing apparatus that transmits print data to a printing apparatus without passing the print data through the server, the method comprising the steps of:
saving, by the printing apparatus, print data received from the information processing apparatus;
transmitting, by the printing apparatus, an identifier for identifying the saved print data to the server; and
managing, by the server, print data saved in the printing apparatus by using the identifier, wherein
at least one of a condition that the server does not support a format of print data transmitted to the printing apparatus without being passed through the server and a condition that the server does not support a protocol that is used at the time of transmission of print data to the printing apparatus without passing the print data through the server is satisfied.

12. A non-transitory computer readable storage medium storing a program that causes a computer to perform a management method of print data that is performed in a printing system including at least a server that holds and manages received print data, and an information processing apparatus that transmits print data to a printing apparatus without passing the print data through the server, the method comprising the steps of:
saving, by the printing apparatus, print data received from the information processing apparatus;
transmitting, by the printing apparatus, an identifier for identifying the saved print data to the server; and
managing, by the server, print data saved in the printing apparatus by using the identifier, wherein
at least one of a condition that the server does not support a format of print data transmitted to the printing apparatus without being passed through the server and a condition that the server does not support a protocol that is used at the time of transmission of print data to the printing apparatus without passing the print data through the server is satisfied.
